(19) United States
(12) Patent Application Publication
(10) Pub. No.: US 2020/0055971 A1
(43) Pub. Date: Feb. 20, 2020

(54) PEROXIDE CURABLE PARTIALLY FLUORINATED POLYMER

(71) Applicant: 3M INNOVATIVE PROPERTIES COMPANY, St. Paul, MN (US)

(72) Inventors: Klaus Hintzer, Kastl (DE); Florian D. Jochum, Neuotting (DE); Harald Kaspar, Burgkirchen (DE); Kai H. Lochhaas, Neuotting (DE); Tilman C. Zipplies, Burghausen (DE)

(21) Appl. No.: 16/346,145

(22) PCT Filed: Nov. 3, 2017
(86) PCT No.: PCT/US2017/059825

§ 371 Date: Apr. 30, 2019

Related U.S. Application Data
(60) Provisional application No. 62/419,583, filed on Nov. 9, 2016.

(51) Int. Cl. C08F 214/22; C08F 214/26; C08F 214/28; C08F 214/18

(52) U.S. Cl. CPC C08F 214/22; C08F 214/184; C08F 214/28; C08F 214/26

(57) ABSTRACT

Described herein is a peroxide curable, partially fluorinated polymer derived from: (a) comonomers comprising: (i) 5-28 wt. % of tetrafluoroethylene; (ii) 30-70 wt. % of vinylidene fluoride; and (iii) a monomer selected from 10-45 wt. % of hexafluoropropylene and 10-40 wt, % of a perfluoro ether monomer of the formula R_{f}-0-(CF₂)ₙ—CF═CF₂ wherein n is 1 or 0, and Rf represents a perfluoroalkyl residue which may or may not be interrupted by one or more than one oxygen atoms; (b) 0.01-2 wt % of a perfluorinated iodinated vinyl ether based on the total amount of comonomer, wherein the perfluorinated iodinated vinyl ether has the formula: F₂C═CF—(CF₂)ₘ(0)ₒ—(CF₂)ₙ—O—(CF₂)ₚ—I where m is 0 or 1; n is an integer of 0-5: o is 0 or 1: and p is an integer of 1-5, wherein when n is 0, o is 0; and (c) 0.01-2 wt % of a chain transfer agent based on the total amount of comonomers wherein the chain transfer agent consists of a diiodo-fluoroalkane and a diiodo-methane. Further described are methods of making the curable partially fluorinated polymers and articles comprising the cured fluoropolymer.

### TECHNICAL FIELD

The present disclosure relates to curable partially fluorinated polymers and methods of making and using the same.

### SUMMARY

There is a desire to identify particular partially fluorinated polymers, which provide improved physical properties. In addition, or alternatively, there is a desire to identify compositions which can be manufactured more cost effectively.

In one aspect, an amorphous partially fluorinated polymer is described, wherein the amorphous partially fluorinated polymer is derived from:
(a) comonomers comprising: (i) 5-28 wt. % of tetrafluoroethylene: (ii) 30-70 wt. % of vinylidene fluoride; and (iii) a monomer selected from 10-45 wt. % of hexafluoropropylene and 10-40 wt. % of a perfluoro ether monomer of the formula

R_{f}—O—(CF₂)ₙ—CF═CF₂
wherein n is 1 or 0, and Rf represents a perfluoroalkyl residue which may or may not be interrupted by one or more than one catenated oxygen atoms;
(b) 0.01-2 wt % of a perfluorinated iodinated vinyl ether based on the total amount of comonomer, wherein the perfluorinated iodinated vinyl ether is of the formula:

F₂C═CF—(CF₂)ₘ—(O)ₒ—(CF₂)ₙ—O—(CF₂)ₚ—I
where m is 0 or 1; n is an integer of 0-5; o is 0 or 1; and p is an integer of 1-5, wherein when n is 0, o is 0; and
(c) 0.01-2 wt % of a chain transfer agent based on the total amount of comonomers wherein the chain transfer agent consists of a diiodo-fluoroalkane and a diiodo-methane.

In another aspect, a cured fluoroelastomer is described. The cured fluoroelastomer is a reaction product of:

(i) an amorphous partially fluorinated polymer derived from (a) comonomers comprising: 5-28 wt. % of tetrafluoroethylene: 30-70 wt. % of vinylidene fluoride: and a monomer selected from 10-45 wt. % of hexafluoropropylene and 10-40 wt. % of a perfluoro ether monomer of the formula

R_{f}—O—(CF₂)ₙ—CF═CF₂
wherein n is 1 or 0, and Rf represents a perfluoroalkyl residue which may or may not be interrupted by one or more than one catenated oxygen atoms;
(b) 0.01-2 wt % of a perfluorinated iodinated vinyl ether based on the total amount of comonomer wherein the perfluorinated iodinated vinyl ether has the formula:

F₂C═CF—(CF₂)ₘ—(O)ₒ—(CF₂)ₙ—O—(CF₂)ₚ—I
where m is 0 or 1; n is an integer of 0-5; o is 0 or 1; and p is an integer of 1-5, wherein when n is 0, o is 0; and
(c) 0.01-2 wt % of a chain transfer agent based on the total amount of comonomer wherein the chain transfer agent consists of a diiodo-fluoroalkane and a diiodo-methane; and
   (ii) a peroxide cure system.

In yet another aspect, a method of polymerizing an amorphous partially fluorinated polymer is described. The method comprises

(i) obtaining (a) comonomers comprising 5-28 wt. % of tetrafluoroethylene; 30-70 wt. % of vinylidene fluoride: and a monomer selected from 10-45 wt. % of hexafluoropropylene and 10-40 wt. % of a perfluoro ether monomer of the formula

R_{f}—O—(CF₂)ₙ—CF═CF₂

wherein n is 1 or 0, and Rf represents a perfluoroalkyl residue which may or may not be interrupted by one or more than one oxygen atoms: and (b) 0.01-2 wt % of a perfluorinated iodinated vinyl ether based on the total amount of comonomer wherein the perfluorinated iodinated vinyl ether has the formula: F₂C═CF—(CF₂)ₘ—(O)ₒ—(CF₂)ₙ—O—(CF₂)ₚ—I where m is 0 or 1: n is an integer of 0-5; o is 0 or 1: and p is an integer of 1-5, wherein when n is 0, o is 0; and
(ii) contacting the comonomers and the perfluorinated iodinated vinyl ether with 0.01-2 wt % of a chain transfer agent wherein the chain transfer agent consists of a diiodo-fluoroalkane and a diiodo-methane; and
(iii) contacting the comonomers and the perfluorinated iodinated vinyl ether with an initiator in the presence of water.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B);

“backbone” refers to the main continuous chain of the polymer;

“crosslinking” refers to connecting two pre-formed polymer chains using chemical bonds or chemical groups:

“cure site” refers to functional groups, which may participate in crosslinking;

“monomer” is a molecule which can undergo polymerization which then forms part of the essential structure of a polymer; and

“polymer” refers to a macrostructure having a number average molecular weight (Mn) of at least 50,000 dalton, at least 100,000 dalton, at least 300,000 dalton, at least 500,000 dalton, at least, 750,000 dalton, at least 1,000,000 dalton, or even at least 1,500,000 dalton and not such a high molecular weight as to cause premature gelling of the polymer.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

During free radical polymerization, monomers are linked together to form a polymer. Because of the random nature of formation, a polymer comprises a distribution of chain lengths.

Terminal iodine groups may be introduced into the polymer during the polymerization using, for example, organic chain transfer agents (such as CF₂I₂ or ICF₂CF₂CF₂CF₂I), and/or fluorinated cure site monomers. Chain transfer agents typically add to the terminal ends of the polymer where polymerization initiates or terminates. Cure site monomers comprise a reactive pendant group such as iodine. The cure site monomers are polymerized into the polymer with the pendant groups located off the polymer backbone resulting in iodine-containing side chains, which are available for subsequent crosslinking.

As used herein above and below, the term “end group” of a polymer is used for groups that are at the terminal positions of both the polymer backbone chain and the terminal positions of side chains.

In the present disclosure, it has been discovered that particular iodo-containing cure site monomers can have advantages over other iodo-containing cure site monomers. Such advantages may include shorter polymerization run times, higher solid content, and/or better incorporation of the iodo-containing cure site monomer into the partially fluorinated polymer (referred to herein interchangeable as the fluoropolymer). The better incorporation of iodine into the fluoropolymer can lead to improved physical properties (such as higher elongation at break, low compression set values, and/or higher trouser tear values) and/or decreased extractables from the cured fluoropolymer.

Curable and Cured Fluoropolymers

The curable and cured fluoropolymers provided herein are partially fluorinated and contain at least 63, 64, 65, 66, 67, or even 68% by weight of fluorine and at most 71, 70.5, or even 70% by weight of fluorine (based on the total weight of the polymer). The fluorine content may be achieved by selecting the monomers and their amounts accordingly. The fluorine content can be determined as nominal fluorine content by determining the amount of comonomers and calculating their fluorine content—by excluding contributions to the fluorine content from other components like, for example, cure site monomers and chain transfer agents.

The fluoropolymers provided herein may be cured (cross-linked) or uncured (non-crosslinked) but curable. Typically, the curable and cured fluoropolymers are amorphous. Typically, they do not have a distinct melting point. Generally, the fluoropolymer has a glass transition temperature (Tg) of less than 20° C., preferably less than 10° C. and most preferably less than 0° C. for example a Tg of between −40° C. and 20° C., or −20° C. and 10° C. or between −15° C. and 0° C. The curable fluoropolymers described herein may typically have a Mooney viscosity (ML 1+10 at 121° C.) of from about 2 to about 150, preferably about 10 to about 100, more preferably from about 20 to about 70.

The curable fluoropolymers are peroxide curable. The curable fluoropolymer contains iodine-containing cure-sites, in particular iodine-containing end groups.

Comonomers

The partially fluorinated polymer (also referred to herein as fluoropolymer) is a copolymer derived from at least the following monomers: (a) tetrafluoroethylene (TFE), (b) vinylidene fluoride (VDF), and (c) a monomer selected from hexafluoropropylene (HFP), a perfluoro ether monomer, or combinations thereof.

The partially fluorinated polymer comprises at least 5, 8, 10 or even 15 wt %; and at most 28, 25 or even 20 wt % of TFE versus the total weight of the fluoropolymer. The partially fluorinated polymer comprises at least 30, 35 or even 40 wt %; and at most 70, 65, or even 60 wt % of VDF versus the total weight of the fluoropolymer.

The partially fluorinated polymer also comprises at least 10, 12, or even 15 wt % and at most 45, 40, 30, 25 or even 20 wt % of HFP versus the total weight of the fluoropolymer; and/or at least 10, 12, or even 15 wt % and at most 40, 38, 35 or even 30 wt % of a perfluoro ether monomer versus the total weight of the fluoropolymer. The perfluoro ether monomer is of formula (I):

R_{f}—O—(CF₂)ₙ—CF═CF₂ (I)

wherein n is 1 (allyl ether) or 0 (vinyl ether) and Rf represents a perfluoroalkyl residue which may or may not be interrupted by one or more than one oxygen atoms. In one embodiment, the perfluoro ether monomer is of the formula (II)

CF₂═CF(CF₂)_{b}O(R_{f′}O)ₙ(R_{f′}O)ₘR_{f} (II)

where R_{f″} and R_{f′} are independently linear or branched perfluoroalkylene radical groups comprising 2, 3, 4, 5, or 6 carbon atoms, m and n are independently an integer selected from 0, 1, 2, 3, 4, 5, 6, 7, 8, 9, and 10, and R_{f} is a perfluoroalkyl group comprising 1, 2, 3, 4, 5, or 6 carbon atoms; wherein b is 0 or 1; n is 0 or 1; and m is 0, 1, 2, 3, 4, or 5.

Exemplary perfluoro ether monomers include: perfluoro (methyl vinyl) ether (PMVE), perfluoro (ethyl vinyl) ether (PEVE), perfluoro-methoxy-propylvinylether (MV-31, CF₃—O—CF₂—CF₂—CF₂—O—CF═CF₂), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, perfluoro-methoxy-methylvinylether (CF₃—O—CF₂—O—CF═CF₂), and CF₃—(CF₂)₂—O—CF(CF₃)—CF₂—O—CF(CF₃)—CF₂—O—CF═CF₂, perfluoro (methyl allyl) ether (CF₂═CF—CF₂—O—CF₃), perfluoro (ethyl allyl) ether, perfluoro (n-propyl allyl) ether, perfluoro-2-propoxypropyl allyl ether, perfluoro-3-methoxy-n-propylallyl ether, perfluoro-2-methoxy-ethyl allyl ether, perfluoro-methoxy-methyl allyl ether, and CF₃—(CF₂)₂—O—CF(CF₃)—CF₂—O—CF(CF₃)—CF₂—O—CF₂CF═CF₂, and combinations thereof. Further examples include vinyl ethers of the general formula: CF₂═CFOCF₂OR wherein R is a C₂-C₆ linear, branched or C₅-C₆ cyclic (per)fluoroalkyl group, or a C₂-C₆ linear, branched (per)fluoro oxyalkyl group containing from one to three oxygen atoms. Specific examples include CF₂═CFOCF₂OCF₂CF₃ and CF₂═CFOCF₂OCF₂CF₂OCF₃.

In one embodiment, the partially fluorinated polymer can comprise additional monomers.

Additional monomers include fluorinated and non-fluorinated alkenes including perhalogenated alkenes such as trifluorochloroethylene (CTFE); partially fluorinated alkenes such as vinyl fluoride, pentafluoropropylene (e.g., 2-hydropentafluropropylene), and trifluoroethylene; and non-fluorinated alkenes such as ethylene, propylene, and isobutylene.

Additional monomers include a fluorinated bisolefin compound represented by the following formula (IV):

CY₂═CX—(CF₂)ₐ—(O—CF(Z)—CF₂)_{b}—O—(CF₂)_{c}—(O—CF(Z)—CF₂)_{d}—(O)ₑ—(CF(A))_{f}—CX═CY₂ (IV)

wherein a is an integer selected from 0, 1, and 2; b is an integer selected from 0, 1, and 2; c is an integer selected from 0, 1, 2, 3, 4, 5, 6, 7, and 8; d is an integer selected from 0, 1, and 2; e is 0 or 1; f is an integer selected from 0, 1, 2, 3.4, 5, and 6; Z is independently selected from F and CF₃; A is F or a perfluorinated alkyl group; X is independently H or F; and Y is independently selected from H, F, and CF. In a preferred embodiment, the fluorinated bisolefin compound is perfluorinated, meaning that X and Y are independently selected from F and CF₃.

Exemplary compounds of the fluorinated bisolefin compound include: CF₂═CF—O—(CF₂)₂—O—CF═CF₂, CF₂═CF—O—(CF₂)₃—O—CF═CF₂, CF₂═CF—O—(CF₂)₄—O—CF═CF₂, CF₂═CF—O—(CF₂)₅—O—CF═CF₂, CF₂═CF—O—(CF₂)₆—O—CF═CF₂, CF₂═CF—CF₂—O—(CF₂)₂—O—CF═CF₂, CF₂═CF—CF₂—O—(CF₂)₃—O—CF═CF₂, CF₂═CF—CF₂—O—(CF₂)₄—O—CF═CF₂, CF₂═CF—CF₂—O—(CF₂)₄—O—CF═CF₂, CF₂═CF—CF₂—O—(CF₂)₅—O—CF═CF₂, CF₂═CF—CF₂—O—(CF₂)₆—O—CF═CF₂, CF₂═CF—CF₂—O—(CF₂)₂—O—CF₂—CF=CF₂, CF₂═CF—CF₂—O—(CF₂)₃—O—CF₂—CF═CF₂, CF₂═CF—CF₂—O—(CF₂)₄—O—CF₂—CF═CF₂, CF₂═CF— CF₂—O—(CF₂)₅—O—CF₂—CF═CF₂, CF₂═CF—CF₂—O—(CF₂)₆—O—CF₂—CF═CF₂, CF₂═CF—O—CF₂CF₂—CH═CH₂, CF₂═CF—(OCF(CF₃)CF₂)—O—CF₂CF₂—CH═CH₂, CF₂═CF—(OCF(CF₃)CF₂)₂—O—CF₂CF₂—CH═CH₂, CF₂═CFCF₂—O—CF₂CF₂—CH═CH₂, CF₂═CF CF₂—(OCF(CF₃)CF₂)—O—CF₂CF₂—CH═CH₂, CF₂═CFCF₂—(OCF(CF₃)CF₂)₂—O—CF₂CF₂—CH═CH₂, CF₂═CF—CF₂—CH═CH₂, CF₂═CF—O—(CF₂)_{c}—O—CF₂—CF₂—CH═CH₂ wherein c is an integer selected from 2 to 6, CF₂═CFCF₂—O—(CF₂)_{c}—O—CF₂—CF₂—CH═CH₂ wherein c is an integer selected from 2 to 6, CF₂═CF—(OCF(CF₃)CF₂)_{b}—O—CF(CF₃)—CH═CH₂ wherein b is 0, 1, or 2, CF₂═CF—CF₂—(OCF(CF₃)CF₂)_{b}—O—CF(CF₃)—CH═CH₂ wherein b is 0, 1, or 2, CH₂═CH—(CF₂)ₙ—O—CH═CH₂ wherein n is an integer from 1-10, and CF₂═CF—(CF₂)ₐ—(O—CF(CF)CF₂)_{b}—O—(CF₂)_{c}—(OCF(CF)CF₂)_{f}—O—CF═CF₂ wherein a is 0 or 1, b is 0, 1, or 2, c is 1, 2, 3, 4, 5, or 6, and f is 0, 1, or 2.

In one embodiment, the fluoropolymer of the present disclosure is substantially free of a fluorinated bisolefin compound of formula (IV). In other words, the fluoropolymer comprises less than 1, 0.5, 0.1, or 0.05 wt % or even no detectable partially fluorinated polymer of formula (IV) versus the fluoropolymer.

The additional monomers may be used to adjust the fluorine content of the fluoropolymer, adjust the glass transition temperature (Tg), and/or reduce cost. These additional monomers would be present at less than 10, 5, 2, 1, or even 0.5 wt % based on the weight of the fluoropolymer.

In a particular embodiment, the fluoropolymer is derived from: 9 wt. % of TFE, 33 wt. % HFP, 58 wt. % VDF and has a Mooney Viscosity (1+10 min, 121° C.) of 46 and an iodine content of 0.42%. In another embodiment the fluoropolymer is derived from 15 wt. % of TFE, 33 wt. % HFP and 52 wt. % VDF and has a Mooney Viscosity of 45 and an iodine content of 0.38 wt. %. In another embodiment, the fluoropolymer is derived from 26 wt. % TFE, 38 wt. % HFP and 36 wt. % VDF and has a Mooney Viscosity of 26 and an iodine content of 0.41 wt. %. In a different example, the fluoropolymers is consisting of 26 wt. % TFE, 37 wt. % HFP, 35 wt. % VDF and 2 wt. % of PMVE and has a Mooney Viscosity of 38 and a iodine content of 0.35 wt. %. In another embodiment, the fluoropolymer is derived from 7 wt. % TFE, 36 wt. % PMVE and 57 wt. % VDF and has a Mooney Viscosity of 25 and an iodine content of 0.40 wt. %.

Cure Site Monomers

The iodinated cure site monomer of the present disclosure, which has been found to increase the amount of iodine in the low molecular weight fractions of the fluroopolymer, is a perfluorinated iodinated ether monomer of formula (III):

F₂C═CF—(CF₂)ₘ—(O)ₒ—(CF₂)ₙ—O—(CF₂)ₚ—I (III)

where m is 0 (vinyl) or 1 (allyl); n is an integer of 1-5; o is 0 or 1; and p is an integer of 0-5, wherein when n is 0, o is 0. Exemplary compounds of Formula (I) include: CF₂═CFOC₄F₈I (MV4I), CF₂═CFOC₂F₄I, CF₂═CFOCF₂CF(CF₃)OC₂F₄I, CF₂═CF—(OCF₂CF(CF₃))₂—O—C₂F₄I, CF₂═CF—O—CF₂CFI—CF₃, CF₂═CF—O—CF₂CF(CF₃)—O—CF₂CFI—CF₃, CF₂═CF—O—(CF₂)₂—O—C₂F₄I, CF₂═CF—O—(CF₂)₃—O—C₂F₄I (IVE), CF₂═CF—O—(CF₂)₄—O—C₂F₄I, CF₂═CF—O—(CF₂)₅—O—C₂F₄I, CF₂═CF—O—(CF₂)₆—O—C₂F₄I, CF₂═CF—CF₂—O—CF₂—O—C₂F₄I, CF₂═CF—CF₂—O—(CF₂)₂—O—C₂F₄I, CF₂═CF—CF₂—O—(CF₂)₃—O—C₂F₄I, CF₂═CF—CF₂—O—(CF₂)₄—O—C₂F₄I, CF₂═CF—CF₂—O—(CF₂)₅—O—C₂F₄I, CF₂═CF—CF₂—O—(CF₂)₆—O—C₂F₄I. CF₂═CF—CF₂—O—C₄FI, CF₂═CF—CF₂—O—C₂F₄I, CF₂═CF—CF₂—O—CF₂CF(CF₃)—O—C₂F₄I, CF₂═CF—CF₂—(OCF₂CF(CF₃))₂—O—C₂F₄I, CF₂═CF—CF₂—O—CF₂CFI—CF₃, CF₂═CF—CF₂—O—CF₂CF(CF₃)O—CF₂CFI—CF₃, and combinations thereof. In one embodiment, preferred compounds of Formula (III) include: CF₂═CFOC₄F₈I; CF₂═CFCF₂OC₄F₈I; CF₂═CFOC₂F₄I; CF₂═CFCF₂OC₂F₄I; CF₂═CF—O—(CF₂)ₙ—O—CF₂—CF₂I and CF₂═CFCF₂—O—(CF₂)ₙ—O—CF₂—CF₂I wherein n is an integer selected from 2, 3, 4, or 6; and combinations thereof. In one embodiment, the partially fluorinated polymer of the present disclosure comprises at least 0.01, 0.1 or even 0.5 wt %; and at most 2, 1.8, or even 1.5 wt % of the perfluorinated iodinated ether monomer of formula (III) versus the total weight of the fluoropolymer.

In one embodiment, additional cure site monomers as known in the art may be polymerized into the fluoropolymer.

As discussed herein, it has been discovered that using the cure site monomers according to formula (III) can be advantageous over other iodinated cure site monomers. In one embodiment, the fluoropolymers of the present disclosure are polymerized in the absence or near absence (such as less than 5, 2, 1, 0.5, or even 0.1 wt %) of iodinated cure site monomer which are not of formula (III). Such iodinated cure site monomer which are not of formula (III) include iodinated fluoroolefins such as I—(R_{f})ᵣ—CX═CX₂ wherein each X independently represents H or F, R_{f} is a C₁-C₁₂ perfluoroalkylene, optionally containing chlorine atoms and r is 0 or 1; and non-fluorinated iodo-olefins such as vinyl iodide, and 4-iodo-1-butene.

In one embodiment, additional cure site monomers may be used which may be reactive to other cure systems for example, but not limited to, bisphenol curing systems or triazine curing systems. In the latter case, the partially fluorinated polymer would be curable by a dual cure system or a multi cure system.

Nitrile-containing cure sites may be reactive to other non-peroxide cure systems for example, but not limited to, bisphenol curing systems or triazine curing systems. Examples of nitrile containing cure site monomers that may be used correspond to the following formula: CF₂═CF—CF₂—O—Rf—CN; CF₂═CFO(CF₂)CN; CF₂═CFO[CF₂CF(CF₃)O]ₚ(CF₂)ᵥOCF(CF₃)CN; CF₂═CF[OCF₂CF(CF₃)]ₖO(CF₂)ᵤCN wherein, r represents an integer of 2 to 12; p represents an integer of 0 to 4; k represents 1 or 2; v represents an integer of 0 to 6; u represents an integer of 1 to 6, Rf is a perfluoroalkylene or a bivalent perfluoroether group. Specific examples of nitrile containing fluorinated monomers include perfluoro (8-cyano-5-methyl-3,6-dioxa-1-octene), CF₂═CFO(CF₂)₅CN, and CF₂═CFO(CF₂)₃OCF(CF₃)CN.

Chain Transfer Agent

Chain transfer agents are used to control the molecular weight of the polymer chains. Iodine containing end groups can be present in the polymer chains, if iodo-containing chain transfer agents are used. However, as mentioned above, the groups will add at the beginning and/or end of the polymer chain and thus only 1 or 2 iodine terminal groups may be present on a polymer chain. In the present disclosure, a diiodo-fluoroalkane and/or a diiodomethane is used as the chain transfer agent. Exemplary diiodo-fluoroalkane chain transfer agents include: I(CF₂)ₙI, where n is an integer from 2-12. The partially fluorinated polymer of the present disclosure is derived using at least 0.01, 0.1, 0.5, or even 0.75 wt %; and at most 2, 1.5 or even 1 wt % of the chain transfer agent based on the total amount of comonomer used.

Methods of Making Curable Fluoropolymers

The fluoropolymers according to the present disclosure can be made by aqueous emulsion polymerization of TFE, VDF, and HFP and/or perfluoro ether monomer described above along with one or more reaction initiator(s), the iodine-containing chain transfer agent described above, the perfluorinated iodinated ethers described above and, optionally, additional monomers. The addition of fluorinated emulsifiers is not necessary and can be avoided altogether. In one embodiment an aqueous polymerization is used in the presence of one or more non-fluorinated emulsifiers.

Preferably a seed composition is used in the polymerization to produce the fluoropolymers. In one embodiment, no fluorinated emulsifier is added to prepare the seed composition. Preferably, no emulsifier, be it fluorinated or non-fluorinated, is added during the polymerization of the fluoropolymer when a seed composition is used.

In one embodiment, if no seed composition is used during polymerization of the fluoropolymer, a non-fluorinated emulsifier may be added prior to the polymerization starting or during the polymerization or both.

Preparation of Seed Compositions

The seed compositions for use in the preparation of the curable fluoropolymers as described herein can be prepared by aqueous emulsion polymerization as known in the art. Ordinary reaction conditions and equipment for preparing fluoropolymers by aqueous emulsion polymerization may also be used to prepare the seed compositions. To make the seed compositions, the comonomers are polymerized in an aqueous emulsion polymerization involving a reaction initiator (hereinafter also referred to as “initiator for making seed particles”) and at least one emulsifier. The emulsifier may be a fluorinated emulsifier or a saturated, non-fluorinated emulsifier or a combination of both. Preferably the emulsifier to produce seed fluoropolymer particles is a saturated non-fluorinated emulsifier. Auxiliaries as known in the art for producing fluoropolymers by aqueous emulsion polymerization may be used, for example buffers and complexing agents. The reaction initiator and the saturated non-fluorinated emulsifier will be described in greater detail below in the respective sub-sections.

The seed composition contains fluorinated seed particles (seed polymers). Seed compositions are typically aqueous dispersions or emulsions of fluorinated seed particles. Typically, the seed particle may have an average particle size (D₅₀) of up to 150 nm. In one embodiment the seed particles typically have an average particle size (D₅₀) of up to 51 nm, for example between about 5 nm and 50 nm, or preferably up to 30 nm, and more preferably between about 15 nm and about 25 nm. The seed composition is obtainable by aqueous emulsion polymerization of comonomers in the presence of an initiator for making seed particles. Typically one or more non-fluorinated emulsifiers as described herein is used in the polymerization. The seed composition can be prepared without adding any fluorinated materials other than the monomers. In particular, the seed composition can be prepared without adding fluorinated emulsifiers and/or without adding any saturated fluorinated compounds like fluorinated hydrocarbons or fluorinated hydrocarbon ethers or polyethers. The reaction mixture may, however, include the presence of buffers and other auxiliaries, for example, non-halogenated chain transfer agents or complexing agents.

The comonomers used for making the seed particles can be the same comonomers used to make the curable fluoropolymers but can also be different comonomers. Suitable comonomers are the same as described above under the section “comonomers”. They may be used in the same combinations and same amounts as described above under the section “comonomers”. Preferably, the comonomers used in the reaction to make seed particles comprise vinylidenfluoride (VDF) and at least one perfluorinated monomer selected from hexafluoropropene (HFP), tetrafluoroethene (TFE), a perfluoroalkylvinyl ether (PAVE), a perfluoroalkylallylether (PAAE), and/or at least one non-fluorinated selected from ethene and propene or a combination thereof. A typical seed composition comprises repeating units derived from VDF, HFP, TFE and, optionally ethene and/or propene.

The amounts of initiators, emulsifiers and monomers are adapted to provide seed particles of the desired particle size.

The seed particles may be amorphous or crystalline, i.e. the seed particles may have a melting point and are crystalline or they may not have a distinct melting point and are elastomeric.

The polymerization to make the seed composition is run to produce seed compositions with seed particles having average particle sizes as described. The seed particles are typically produced in amounts of from about 0.05 to about 5% by weight based on the total weight of the seed composition, for example 0.5 to 4.5% by weight. Preferably, all ingredients are fed in the reaction vessel before the reaction initiator is added. The reaction initiator may be fed continuously, e.g., at a slow rate, to the composition to start the reaction. However, the reaction initiator may also be added in intervals or at a single dose or by a combination thereof. The reaction initiators to prepare the seed composition can be the same or different reaction initiators used to make the curable fluoropolymers (referred hereinafter also referred to as “initiators for preparing curable fluoropolymers”). Standard initiators for the polymerization of fluoropolymers may be used, in particular standard initiators for aqueous emulsion polymerizations. Typically the initiators are compounds that decompose to produce free radicals under the reaction conditions. General examples include peroxides, preferably inorganic peroxides, and permanganates. Specific examples include, but are not limited to, ammonium permanganate, potassium permanganate, potassium or ammonium sulfinate, ammonium peroxodisulfate, potassium peroxodisulfate or combinations thereof. Preferably, water soluble reaction initiators arc used. The reaction initiators may be used in combination with reducing agents as known in the art (typical examples include transition metal salts, hydroxyl acids, halogen salts, oxoacids or oxyacids of sulfur). Redox initiator systems may also be used, including but not limited to a combination of a peroxodisulfate salt and a bisulfite salt.

To avoid generation of metal content which may be detrimental in some applications, ammonium salts may be used instead of alkali salts.

In one embodiment the reaction initiators for preparing the seed compositions include peroxodisulfates with or without combination with reducing agents. In one embodiment the reaction initiators for preparing the seed compositions include permanganates with or without combination with reducing agents. In one embodiment the reaction initiators for preparing the seed compositions do not include permanganates.

Seed polymerization compositions and method are known in the art. For example, disclosed in EP 1726599 B1 (Otsuka et al.) or WO 2016/137851 (Jochum et al.), which are incorporated by reference.

Saturated Non-Fluorinated Emulsifiers:

The saturated, non-fluorinated emulsifiers to be used are referred herein above and below simply as “non-fluorinated emulsifiers”. The saturated non-fluorinated emulsifiers may be anionic or non-ionic. They are preferably used in amounts of from about 50 to 4,000 ppm, more preferably in amounts from about 100 to 3000 ppm based on the aqueous phase of the seed composition. Their amount may be adapted to the amounts of initiators and monomers used to obtain seed particles of the desired particle size.

Non-Ionic, Saturated, Non-Fluorinated Emulsifiers:

Typical non-ionic, non-fluorinated saturated emulsifiers include polycaprolactones, siloxanes, polyethylene/polypropylene glycols (cyclodextrines), carbosilanes and sugar-based emulsifiers. Other examples include polyether alcohols, sugar-based emuslifiers or hydrocarbon based emulsifiers. The long chain unit may contain from 4 to 40 carbon atoms. Typically, it is based on a hydrocarbon chain. It typically contains or consist of hydrocarbon or a (poly)oxy hydrocarbon chain, i.e. a hydrocarbon chain that is interrupted once or more than once by an oxygen atom. Typically the long chain unit is an alkyl chain or a (poly)oxy alkyl chain, i.e. an alkyl chain that is interrupted once or more than once by an oxygen atom to provide a catenary ether function. The long chain unit may be linear, branched or cyclic but preferably is acyclic and contain one or more polar functional non-ionic group.

Non-Fluorinated Saturated Anionic Emulsifiers:

Suitable non-fluorinated, saturated anionic emulsifiers include polyvinylphosphinic acids, polyacrylic acids and polyvinyl sulfonic acids alkyl phosphonic acids (for example, alkyl phosphates, hydrocarbon anionic surfactants as described, for example in EP 2 091 978 and EP 1 325 036, herein incorporated by reference).

Particular embodiments of anionic emulsifiers include sulfate or sulfonate emulsifiers, typically hydrocarbon sulfates or sulfonates wherein the hydrocarbon part may be substituted by one or more catenary oxygen atoms, e.g. the hydrocarbon part may be an ether or polyether residue. The hydrocarbon part is typically aliphatic. The hydrocarbon part may contain from 8 to 26, preferably from 10 to 16 or from 10 to 14 carbon atoms. In a preferred embodiment the non-fluorinated emulsifiers are sulfonates, for example monosulfonates or polysulfonates, e.g. disulfonates, preferably secondary sulfonates.

Other examples of oxygen containing moieties include carboxylate ester (—O—C(═O)—) groups and carboxamide (—NYX—C(═O)— groups wherein Y and X may be H, or an alkyl groups, preferably a methyl or ethyl group and combinations thereof.

Examples of commercially available sulfonate or sulfate emulsifiers with one or more oxygen containing moieties include, but are not limited to GENAPOL LRO (alkyl ether sulfate); EMULSOGEN SF; AEROSOL OT 75 (dialkyl sulfosuccinates): HOSTAPON SCI 65 C (alkyl fatty acid isethionate) sulfonate), HOSTAPON CT: ARKOPON T8015 (fatty acid methyl taurides) from Clariant.

The non-fluorinated emulsifiers described above may be added to the reaction mixture prior to the polymerization to make seed particles. The non-fluorinated emulsifiers described herein can also be added intermittently or continuously over the course of polymerization, for example after a part of the total amount of the non-fluorinated emulsifiers had been pre-charged.

Fluorinated Emulsifiers

Fluorinated emulsifiers include compounds that correspond to the general formula:

Y—R_{f}—Z-M

wherein Y represents hydrogen, Cl or F; R_{f} represents a linear, cyclic or branched perfluorinated or partially fluorinated alkylene having 4 to 18 carbon atoms and which may or may not be interrupted by one or more ether oxygens, Z represents an acid anion (e.g. COO⁻ or SO₃⁻) and M represents a cation like an alkali metal ion, an ammonium ion or H⁺. Exemplary emulsifiers include: perfluorinated alkanoic acids, such as perfluorooctanoic acid and perfluorooctane sulphonic acid. Preferably, the molecular weight of the emulsifier is less than 1,000 g/mole.

Specific examples are described in, for example, US Pat. Publ. 2007/0015937 (Hintzer et al.). Exemplary emulsifiers include: CF₃CF₂OCF₂CF₂OCF₂COOH, CHF₂(CF₂)₅COOH, CF₃(CF₂)₆COOH, CF₃O(CF₂)₃OCF(CF₃)COOH, CF₃CF₂CH₂OCF₂CH₂OCF₂COOH, CF₃O(CF₂)₃OCHFCF₂COOH, CF₃O(CF₂)₃OCF₂COOH, CF₃(CF₂)₃(CH₂CF₂)₂CF₂CF₂CF₂COOH, CF₃(CF₂)₂CH₂(CF₂)₂COOH, CF₃(CF₂)₂COOH, CF₃(CF₂)₂(OCF(CF₃)CF₂)OCF(CF₃)COOH, CF₃(CF₂)₂(OCF₂CF₂)₄OCF(CF₃)COOH, CF₃CF₂O(CF₂CF₂O)₃CF₂COOH, and their salts.

The curable fluorinated polymers according to the present disclosure are essentially free of any added fluorinated emulsifiers, preferably they are free of any added fluorinated emulsifiers. This means no fluorinated emulsifiers have been added to the seed or to the subsequent polymerization or fluorinated emulsifiers have been added in an amount of less than 50 ppm based on the respective aqueous phase, or the fluorinated emulsifiers have been reduced to that amount before the polymerization to produce curable fluoropolymers is started. For example, the seed compositions may be subjected to an anion exchange treatment as known in the art to remove fluorinated emulsifiers. Therefore, the curable fluoropolymers are essentially free of added emulsifiers. “Essentially free” as used herein means no added fluorinated emulsifier or amounts of from >0 ppm and up to 50 ppm of added fluorinated emulsifier based on the aqueous phase in case of fluoropolymer dispersions or based on the total amount of fluoropolymer (solid content) in case of isolated fluoropolymers.

Emulsifiers are preferably added for the aqueous emulsion polymerization making the seed composition. The emulsifiers may be fluorinated emulsifier or non-fluorinated emulsifiers or a combination thereof. Preferably, no fluorinated emulsifiers are added. If fluorinated emulsifiers are added in the preparation of the seed composition, they may be added in an amount of less than 50 ppm based on the aqueous phase used to make the seed composition or they may be added in greater amounts but are then removed by anion-exchange to below 50 ppm.

The seed compositions preferably have a solid content of 0.05 to 5% by weight.

Methods of Making Curable Fluoropolymers

The curable fluoropolymers can be prepared by aqueous emulsion polymerization. The monomers are fed to reaction vessels and the reaction is carried out in the presence of an initiator for producing curable fluoropolymers. Further present are the diiodo-fluoroalkane and/or diiodo-methane chain transfer agents as described above. The monomers are those described above under the section “comonomers”. The initiator for producing curable fluoropolymers and the iodine-containing chain transfer agents will be described in greater detail below.

In one embodiment the polymerization is conducted in the presence of one or more of the non-fluorinated emulsifiers as described above, but not as a seed polymerization. The polymerization can be carried out as known in the art. The non-fluorinated emulsifier as described herein, or a mixture thereof (-also referred to herein above and below as “more than one emulsifier”) may be added to the reaction mixture before the polymerization reaction is initiated or during the polymerization reaction of both, but preferably before the reaction is initiated.

In one embodiment a seed composition as described above is used to prepare the curable fluoropolymers. The seed composition may be generated in situ, which means the reaction is carried out as a quasi-single step reaction. This means the seed composition is generated and then a dilution step may be carried out. The dilution may be carried to provide between 0.5 and 5% by weight of fluoropolymer seed particles based on the amount of aqueous phase to be used in the polymerization to produce the curable fluoropolymers. After the dilution the polymerization may be continued with the same monomers or with different monomers. After the dilution the polymerization may be carried out with the same initiators or different ones. The seed composition may also be prepared separately and may be subjected to a purification step (for example thermal treatment or ion-exchange treatment to remove initiators or fluorinated emulsifiers if present, as known in the art and described, for example, in WO 00/35971 and ion-exchange references cited therein, incorporated herein by reference) before being used in the polymerization to produce the curable fluoropolymers. The seed composition may have the same or a different comonomer composition as the comonomer composition used in the subsequent polymerization to produce the curable fluoropolymers. The seed composition may also be diluted or up concentrated to the solid content desired in the subsequent polymerization. The seed composition described above may be pre-charged, meaning the monomers are added to the seed composition, or vice versa, the monomers may be pre-charged and the seed composition is added or some of the monomers are pre-charged and the seed composition is added together with monomers. Typically, the seed composition may be used in an amount of 0.01 up to 5%, preferably 0.5 to 4.5%, by weight of seed particles (solid content) based on the amount of aqueous phase used in the polymerization to produce curable fluoropolymers. The seed composition may be diluted for this purpose.

In case a seed composition is used, the polymerization to produce curable fluoropolymers can be carried out without adding any fluorinated or non-fluorinated emulsifiers, although the addition of further emulsifiers may not be detrimental to the polymerization but will of course increase the emulsifier content, which may be undesired. Preferably, the polymerization is carried out without adding any fluorinated or non-fluorinated emulsifiers.

The aqueous polymerization to prepare the curable fluoropolymers can be carried out as known in the art and involves reacting the comonomers, including the perfluorinated iodinated vinyl ether cure site monomer, in the presence of the chain transfer agent (diiodo-fluoroalkane and/or diiodo-methane). Also present may be, for example, auxiliaries like buffers, other monomers and other cure-site monomers, such as but not limited to, ethers, alcohols and esters, in particular hydrocarbon ester (malonic acid esters), ethers (dimethyl ethers), alcohols (ethanol) and hydrocarbons like ethane.

Reaction Initiators for Producing Curable Fluoropolymers

The reaction initiator may be the same reaction initiators as described for making the seed composition or they may be different. For example, an inorganic initiator may be used to make the seed and an organic initiator may be used to produce the polymer or vice versa.

As reaction initiators, standard initiators for the polymerization of fluoropolymers may be used, in particular standard initiators for aqueous emulsion polymerizations. Typically the initiators are compounds that decompose to produce free radicals under the reaction conditions. Examples include, but are not limited to, peroxo compounds. Specific examples of inorganic initiators include, but are not limited to, ammonium permanganate, potassium permanganate, potassium or ammonium sulfinate, ammonium peroxodisulfate, potassium peroxodisulfate or combinations thereof. For the polymerization to produce curable fluoropolymers also organic peroxides, including but not limited to benzoyl peroxide, tert butyl hydroperoxides, tert butyl pivalates may be used. To avoid generation of metal content which may be detrimental in some applications, ammonium salts may be used instead of alkali salts. Generally, the initiators may be used in a range of from about 0.001-about 0.2 weight % based on the total amount of comonomers. Redox initiators may be used in combination with catalysts (e.g. heavy metal ions, for example copper ions and/or iron ions). In one embodiment the reaction initiator is a peroxodisulfate.

Chain Transfer Agents

The present disclosure uses a diiodo-fluoroalkane and/or a diiodo-methane chain transfer agent (CTA) as discussed above.

In one embodiment, the total amount of the CTA may be pre-charged, i.e. may be added to the polymerization system prior to the polymerization. In one embodiment the total amount of the CTA is charged within 0.5 h from the beginning of the polymerization (i.e. from the moment at which the initiator is activated). In one embodiment of the present disclosure the CTA may be added in emulsified form or may be emulsified in the seed composition. Emulsification may be added by using heat or shear forces.

Cure Site Monomers (CSM)

The cure site monomers described above may be added to the polymerization. They may be added intermittently during the course of polymerization in undiluted form or alternatively diluted with monomers or in emulsified form using the non-fluorinated emulsifiers described above or other emulsifiers. The CSMs can also be introduced into the kettle as an aerosol or sprayed into the kettle as fine droplets.

Comonomers

The comonomers described above may be used in the amounts as described above. They may be added continuously or batchwise.

The polymerization temperature typically is in the range of about 50° C. to about 150° C., preferably from about and including 70° C. to about and including 90° C. The polymerization may be carried out continuously or batchwise. The polymerization may be carried out to generate multimodal or monomodal polymer populations. The polymerization may be run to generate core-shell particles or not to generate core-shell particles.

Fluoroelastomer Compositions

The curable fluoropolymers obtainable by the methods described above may be used to make fluoroelastomer compositions. The resulting aqueous dispersions are typically treated to isolate the fluoropolymer generated, for example by coagulation, which may be done mechanically by increasing shear force, by chilling out, or by salting out. The isolated fluoropolymer may then be washed several times with (distilled) water and dried. The curable fluoropolymer may be subjected to grinding or to melt-shaping, like pelletizing. The curable fluoropolymer may be mixed with one or more curing agents to yield a fluoroelastomer composition. Typically, the fluoroelastomer compositions are solid compositions.

In the present disclosure, it has been discovered that the perfluorinated iodinated vinyl ether cure site monomers of the present disclosure can have advantages over other iodo-containing cure site monomers. In one embodiment, the perfluorinated iodinated vinyl ether cure site monomers of the present disclosure have an improved space-time yield. Space-time yield is a term used in polymer chemistry that describes the polymerization run time versus the amount of polymer generated. Typically one wants to decrease the polymerization run time while maintaining or increasing the polymer yield to run a cost effective process. In one embodiment of the present disclosure, it has been discovered that the perfluorinated iodinated vinyl ether monomers disclosed herein have improved space-time yield as compared to an iodinated perfluoroolefin. See Ex-I versus CE-1 below. Because the perfluorinated iodinated vinyl ether monomers disclosed herein appear to have adequate space-time yield, less initiator may be used during the polymerization, which can allow further improvements in the resulting polymer, such as an increased ratio of —CF₂CH₂I to —CF₂CH₂OH as shown in Example 1 versus Example 4 below.

In one embodiment the resulting partially fluorinated polymer comprises 0.01 to 3 wt % of iodine. In one embodiment, the partially fluorinated polymer of the present disclosure comprises at least 0.05, 0.1, 0.2 or even 0.3% by weight iodine relative to the total weight of the polymer gum. In one embodiment the partially fluorinated polymer gum of the present disclosure comprises at most 0.4, 0.5, or even 0.75% by weight iodine relative to the total weight of the partially fluorinated polymer gum.

The wt % of iodine mentioned above is a measure of how much iodine is present in the fluoropolymer composition with no indication of the iodine location. Ideally, the iodine is present in an endgroup of the fluoropolymer, which can be used for subsequent crosslinking. Thus, by examining the ratio of —CF₂CH₂I groups versus —CF₂CH₂OH groups in the curable fluoropolymer, one can better understand how many iodo end groups are present and the incorporation of iodine into the polymer for a given polymer.

In general, to achieve sufficient peroxide cure, the fluoropolymer should have a high ratio of iodine end groups versus hydroxyl end groups. For example the ratio of —CF₂CH₂I groups versus —CF₂CH₂OH groups in curable fluoropolymers should be at least 25 or at least 35. In one embodiment, the perfluorinated iodinated vinyl ether cure site monomers of the present disclosure have better incorporation into the fluoropolymer. This better incorporation can be observed by high ratios of —CF₂CH₂I to —CF₂CH₂OH.

Additionally, or alternatively to the high ratios of —CF₂CH₂I to —CF₂CH₂OH, the perfluorinated iodinated vinyl ether cure site monomers of the present disclosure have a more homogeneous incorporation of the cure sites over the polymer population and a more effective incorporation of iodinated materials into the polymer chains than other iodo-containing cure site monomers. It is believed that there is better incorporation of iodine into the low molecular weight fractions of the fluoropolymer. For example, in molecular weight fractions having a number average molecular weights (Mn) of less than 20,000 or even 10,000 gram/mole.

The effectiveness of incorporation of the iodo cure site monomers can be determined by (i) measuring amount of iodine across molecular weight fractions of the fluoropolymer or (ii) by measuring the extractables present in the fluoropolymer composition.

Size exclusion chromatography can be used to separate the fluoropolymer based on molecular weight and detecting the amount of iodine in each fraction. In one embodiment, the fluoropolymers of the present disclosure have more iodine incorporated into the low molecular weight fractions than fluoropolymers made not using the perfluorinated iodinated vinyl ether disclosed herein.

The fluoropolymers provided herein may have a reduced amount of extractable materials believed to be oligomeric material or low molecular weight iodinated material that did not get incorporated into the polymer. In one embodiment, the fluoropolymers of the present disclosure have an amount of extractable materials (“extractables”) of less than 4.0, 3.0, 2.0, 1.0, 0.70, or even 0.50 wt %. In one embodiment, the fluoropolymers of the present disclosure have an amount of extractables between 0.5 and 2.5%.

Another advantage of the present disclosure is that peroxide curable fluoropolymers with a rather small particle size can be generated. For example, fluoropolymer dispersion with particle sizes (Z-average) of from about 50 to about 300 nm, or from about 80 to 250 nm can be generated by the methods described herein. Such fluoropolymer dispersions are rather stable, which allows the polymerizations to be carried out to create fluoropolymers of high molecular weight.

A peroxide cure system can be used to cure the partially fluorinated amorphous polymer of the present disclosure to form a fluoroclastomer. The peroxide cure systems typically include an organic peroxide. The peroxide will cause curing of the fluoropolymer to form a cross-linked (cured) fluoropolymer when activated. Suitable organic peroxides are those which generate free radicals at curing temperatures. A dialkyl peroxide or a bis(dialkyl peroxide) which decomposes at a temperature above 50° C. is especially preferred. In many cases it is preferred to use a di-tertiarybutyl peroxide having a tertiary carbon atom attached to the peroxy oxygen. Among the most useful peroxides of this type are 2,5-dimethyl-2,5-di(tertiarybutylperoxy)hexyne-3 and 2,5-dimethyl-2,5-di(tertiarybutylperoxy)hexane. Other peroxides can be selected from compounds such as but not limited to dicumyl peroxide, dibenzoyl peroxide, tertiarybutyl perbenzoate, dialkyl peroxide; bis (dialkyl peroxide); alpha,alpha′-bis(t-butylperoxy-diisopropylbenzene), dibenzoyl peroxide; 2,4-dichlorobenzoyl peroxide; tertiarybutyl perbenzoate; di(t-butylperoxy-isopropyl)benzene; t-butyl peroxy isopropylcarbonate, t-butyl peroxy 2-ethylhexyl carbonate, t-amyl peroxy 2-ethylhexyl carbonate, t-hexylperoxy isopropyl carbonate, di[1,3-dimethyl-3-(t-butylperoxy)butyl]carbonate, carbonoperoxoic acid, O,O′-1,3-propanediyl OO,OO′-bis(1,1-dimethylethyl) ester, and di[1,3-dimethyl-3-(t-butylperoxy)-butyl]carbonate. Generally, the amount of peroxide used generally will be at least 0.1, 0.2, 0.4, 0.6, 0.8, 1, 1.2, or even 1.5; at most 2, 2.25, 2.5, 2.75, 3, 3.5, 4, 4.5, 5, or even 5.5 parts by weight per 100 parts of partially fluorinated polymer.

The curing agents may be present on carriers, for example silica containing carriers.

A peroxide cure system may also include one or more coagent. Typically, the coagent includes a polyunsaturated compound which is capable of cooperating with the peroxide to provide a useful cure. These coagents can be added in an amount of at least 0.5, 1, 1.5, 2, 2.5, 3, 4, 4.5, 5, 5.5, or even 6; at most 4, 4.5, 5, 5.5, 6, 7, 8, 9, 10, 10.5, or even 11 parts by weight per 100 parts of the fluoropolymer. Examples of useful coagents include triallyl cyanurate; triallyl isocyanurate; triallyl trimellitate; tri(methylallyl)isocyanurate; tris(diallylamine)-s-triazine: triallyl phosphite; (N,N′)-diallyl acrylamide; hexaallyl phosphoramide; (N,N,N,N)-tetraalkyl tetraphthalamide: (N,N,N,N-tetraallylmalonamide; trivinyl isocyanurate; 2,4,6-trivinyl methyltrisiloxane; N,N′-m-phenylenebismaleimide; diallyl-phthalate and tri(5-norbomene-2-methylene)cyanurate. Particularly useful is triallyl isocyanurate. Another useful coagent may be represented by the formula CH2=CH—Rfl-CH═CH2 wherein Rfl may be a perfluoroalkylene of 1 to 8 carbon atoms. Such coagents provide enhanced mechanical strength to the final cured elastomer.

The curable fluoropolymer composition may further contain acid acceptors. Such acid acceptors can be inorganic or blends of inorganic and organic acid acceptors. Examples of inorganic acceptors include magnesium oxide, lead oxide, calcium oxide, calcium hydroxide, dibasic lead phosphate, zinc oxide, barium carbonate, strontium hydroxide, calcium carbonate, hydrotalcite, etc. Organic acceptors include epoxies, sodium stearate, and magnesium oxalate. Particularly suitable acid acceptors include magnesium oxide and zinc oxide. Blends of acid acceptors may be used as well. The amount of acid acceptor will generally depend on the nature of the acid acceptor used. In one embodiment, the curable fluoropolymer is essentially free of an acid acceptor (i.e., the composition comprises less than 1, 0.5, 0.25, 0.1, or even less than 0.05 parts per 100 parts of the fluoropolymer). In one embodiment, the curable fluoropolymer comprises an acid acceptor. For example, at least 1.5, 2, 4, 5, or even 6 parts acid acceptor per 100 parts of the fluoropolymer.

The curable fluoropolymer compositions may contain further additives, such as stabilizers, plasticizers, lubricants, fillers, and processing aids typically utilized in fluoropolymer compounding, provided they have adequate stability for the intended service conditions. A particular example of additives includes carbon particles, like carbon black, graphite, soot.

The curable fluoropolymer compositions may be prepared by mixing the fluoropolymer, a peroxide cure composition and optionally additives in conventional rubber processing equipment to provide a solid mixture, i.e. a solid polymer containing the additional ingredients, also referred to in the art as a “compound”. This process of mixing the ingredients to produce such a solid polymer composition containing other ingredients is typically called “compounding”. Such equipment includes rubber mills, internal mixers, such as Banbury mixers, and mixing extruders. The temperature of the mixture during mixing typically will not rise above about 120° C. During mixing the components and additives are distributed uniformly throughout the resulting fluorinated polymer “compound” or polymer sheets. The “compound” can then be extruded or pressed in a mold, e.g., a cavity or a transfer mold and cured in the mold or transferred to an oven and subsequently be oven-cured. In an alternative embodiment curing can be done in an autoclave. Curing is typically achieved by heat-treating the curable fluoropolymer composition. The heat-treatment is carried out at an effective temperature and effective time to create a cured fluoroelastomer. Optimum conditions can be tested by examining the fluoroelastomer for its mechanical and physical properties. Typically, press curing is carried out at temperatures greater than 120° C. or greater than 150° C. Typical press curing conditions include curing at temperatures between 160° C. and 210° C. or between 160° C. and 190° C. Typical curing periods include from 3 to 90 minutes. Curing is preferably carried out under pressure. For example pressures from 10 to 100 bar may be applied. A post curing cycle may be applied to ensure the curing process is fully completed. Post curing may be carried out at a temperature between 170° C. and 250° C. for a period of 1 to 24 hours.

The curable fluoropolymers provided herein may typically have an onset of cure (Ts2) of less than 1 minute at 180° C.

The method described above allows for the provision of cured fluoropolymers having good mechanical properties. The cured fluoroelastomers are the reaction product of the curable fluoropolymers described herein with a peroxide cure system. Such cross-linked polymers are obtainable by curing the curable fluoropolymers in the presence of a cure peroxide system. The resulting cured fluoroelastomers may have good mechanical properties which mean they may have one or more or all of the following properties:

(i) an elongation at break of at least 150%, preferably at least 180% or even at least 210% (for a specific fluorine polymer composition and compound formulation);
(ii) at an elongation at break of at least 210% a VDA compression set of lower than 50, more preferable of lower than 45 and most preferable of lower than 40 (for a specific fluorine polymer composition and compound formulation)
(iii) a tensile strength of at least 12 or at least 15 MPa, preferably at least 18 MPa; (for a specific fluorine polymer composition and compound formulation)
(iv) a Shore A hardness of at least 30, preferably at least 40:
(v) a compression set of less than 25% (ASTM 395, method B, press curing at 40 bar for 7 minutes at 177° C. and post cure of 2 hours at 230° C.) and/or a VDA compression set of less than 45% (VDA 675218), curing for 22 hours at 150° C. (for a specific fluorine polymer composition and compound formulation);
(vi) a [—CF₂—CH₂—I]/[—CF₂CH₂—OH] molar ratio of at least 25; and
(vii) a trouser tear of at least 2.0 kN/m, more preferably 3.5 kN/or higher.

The above properties can depend for example on the amount of fluorine in the resulting polymer. In one embodiment, the fluoropolymer has a tensile strength of at least 12 or at least 15 MPa, a Shore A hardness of at least 40, and an elongation at break of at least 100%.

The curable and cured fluoropolymers may be used to prepare shaped articles. Such articles may be prepared by providing a curable fluoropolymer composition and adding further ingredients such as filler, pigments, plasticizers, lubricants and the like to the curable composition. Typical fillers include, for example, silica containing materials or carbon particles like carbon blacks, graphite, soot and the like. Shaping the composition into a shaped article may be carried out, for example, by curing the composition in shaped molds or by shaping cured compositions by means known in the art, for example by cutting die cutting and the like.

The shaped articles include, for example, tubings, pipes, hoses, seals, stoppers, gaskets, flat seals, O-rings and the like. The articles may be used as components in combustion engines, vehicles driven by combustion engines, shaft seals or components thereof, seals or barrier materials or connectors of a chemical processing apparatus, in particular in oil and gas processing, such as storage and transportation containers, as components for compression or decompression devices or valves.

It is believed that in one embodiment, the partially fluorinated polymer gums have a polymer architecture that favorably influences the mechanical properties and/or the curing behavior of the partially fluorinated polymer by generating branched polymers, particularly when used in small amounts.

A further advantage of the polymers provided herein is that polymers can be prepared without using great amounts of fluorinated emulsifiers or using no fluorinated emulsifiers at all. The polymerization may be carried out in the presence of non-fluorinated emulsifiers and/or may be carried out by using a seed composition. The seed compositions may be prepared in the presence of fluorinated emulsifiers and/or in the presence of non-fluorinated emulsifiers. Since only very little amounts of seed composition may be required, the fluoropolymers may be prepared by using no or only very little amounts of fluorinated emulsifiers or non-fluorinated emulsifiers.

Exemplary embodiments of the present disclosure include, but are not limited to the following:

### Embodiment I

An amorphous partially fluorinated polymer derived from:
(a) comonomers comprising: (i) 5-28 wt. % of tetrafluoroethylene; (ii) 30-70 wt. % of vinylidene fluoride; and (iii) a monomer selected from 10-45 wt. % of hexafluoropropylene and 10-40 wt. % of a perfluoro ether monomer of the formula

R_{f}—O—(CF₂)ₙ—CF═CF₂
wherein n is 1 or 0, and Rf represents a perfluoroalkyl residue which may or may not be interrupted by one or more than one oxygen atoms;
(b) 0.01-2 wt % of a perfluorinated iodinated vinyl ether based on the total amount of comonomer, wherein the perfluorinated iodinated vinyl ether has the formula:

F₂C═CF—(CF₂)ₘ(O)ₒ—(CF₂)ₙ—O—(CF₂)ₚ—I
where m is 0 or 1; n is an integer of 0-5; o is 0 or 1; and p is an integer of 1-5, wherein when n is 0, o is 0; and
(c) 0.01-2 wt % of a chain transfer agent based on the total amount of comonomers wherein the chain transfer agent consists of a diiodo-fluoroalkane and a diiodo-methane.

### Embodiment 2

The amorphous partially fluorinated polymer of embodiment 1, wherein the perfluoro ether monomer is selected from: perfluoro (methyl vinyl) ether, perfluoro (propyl vinyl) ether, perfluoro-methoxy-propylvinylether, perfluoro-2-propoxypropylvinyl ether, perfluoro (methyl allyl) ether, perfluoro (propyl allyl) ether, perfluoro-methoxy-propylallylether, and perfluoro-2-propoxypropylallyl ether.

### Embodiment 3

The amorphous partially fluorinated polymer of any one of the previous embodiments, wherein the amorphous partially fluorinated polymer is further derived from 0.5-10 wt % of an alkene monomer consisting of an alkene and a fluorinated alkene.

### Embodiment 4

The amorphous partially fluorinated polymer of embodiment 3, wherein the alkene monomer consists of ethylene and propylene.

### Embodiment 5

The amorphous partially fluorinated polymer of any one of the previous embodiments, wherein the fluorinated alkene monomer consists of chlorotrifluoroethylene, vinyl fluoride, trifluoroethene, and 1,1,2,3,3,3-pentafluoropropene, 2,3,3,3-tetrafluoropropene.

### Embodiment 6

The amorphous partially fluorinated polymer of any one of the previous embodiments, wherein the amorphous partially fluorinated polymer is further derived from a perfluorinated divinyl ether monomer.

### Embodiment 7

The amorphous partially fluorinated polymer of embodiment 6, wherein the perfluorinated divinyl ether monomer is of the general formulas:

CF₂═CF—O—Rf₁—O—CF═CF₂ (I),

CF₂═CF—CF₂—O—Rf₁—O—CF₂—CF═CF₂ (II), or

CF₂═CF—CF₂—O—Rf₁—O—CF═CF₂ (III)
wherein Rf₁ is a linear or branched perfluoroalkanediyl, perfluorooxaalkanediyl or perfluoropolyoxaalkanediyl residue.

### Embodiment 8

The amorphous partially fluorinated polymer of any one of the previous embodiments, wherein the perfluorinated iodinated vinyl ether consists of: ICF₂—O—CF═CF₂, ICF₂CF₂—O—CF═CF₂, ICF₂CF₂CF₂—O—CF═CF₂, and CF3CFICF₂—O—CF═CF₂.

### Embodiment 9

The amorphous partially fluorinated polymer of any one of the previous embodiments, wherein the diiodo-fluoroalkane is a diiodo-perfluoropropane or a diiodo-perfluorobutane.

### Embodiment 10

The amorphous partially fluorinated polymer of any one of the previous embodiments, wherein the amorphous partially fluorinated polymer is substantially free of a fluorinated emulsifier.

### Embodiment 11

A cured fluoroelastomer composition comprising the reaction product of a curing reaction of the amorphous partially fluorinated polymer according to any one of embodiments 1-10 and a peroxide cure system.

### Embodiment 12

A shaped article comprising the cured amorphous partially fluorinated polymer according embodiment 11.

### Embodiment 13

The shaped article of embodiment 12 selected from at least one of a hose, a tube, a seal, and an O-ring.

### Embodiment 14

A method of polymerizing an amorphous partially fluorinated polymer comprising:
(a) providing the following comonomers: 5-28 wt. % of tetrafluoroethylene; 30-70 wt. % of vinylidene fluoride; and a monomer selected from 10-45 wt. % of hexafluoropropylene and 10-40 wt. % of a perfluoro ether monomer of the formula

R_{f}—O—(CF₂)ₙ—CF═CF₂
wherein n is 1 or 0, and Rf represents a perfluoroalkyl residue which may or may not be interrupted by one or more than one oxygen atoms; and 0.01-2 wt % of a perfluorinated iodinated vinyl ether based on the total amount of comonomers, wherein the perfluorinated iodinated vinyl ether is of the formula:

F₂C═CF—(CF₂)ₘ—(O)ₒ—(CF₂)ₙ—O—(CF₂)ₚ—I
where m is 0 or 1; n is an integer of 0-5; o is 0 or 1; and p is an integer of 1-5, wherein when n is 0, o is 0;
(b) contacting the comonomers and the perfluorinated iodinated vinyl ether with 0.01-2 wt % of a chain transfer agent wherein the chain transfer agent consists of a diiodo-fluoroalkane and a diiodo-methane; and
(c) contacting the comonomers and the perfluorinated iodinated vinyl ether with an initiator in the presence of water.

### Embodiment 15

The method of embodiment 14, wherein the polymerization is substantially free of a fluorinated surfactant.

### Embodiment 16

The method of any one of embodiments 14-15, wherein the polymerization is substantially free of a non-aqueous solvent.

### Embodiment 17

The method of any one of embodiments 14-16, further comprising providing a seed composition in the presence of the monomers.

### Embodiment 18

The method of any one of embodiments 14-17, further comprising a sugar-based emulsifier.

### Embodiment 19

The method of embodiment 18, wherein the sugar-based emulsifier is a glycoside.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials were obtained or are available, from general chemical suppliers such as, for example. Sigma-Aldrich Company, Saint Louis, Mo., or Anles, St. Petersburg, Russia, or may be synthesized by conventional methods.

These abbreviations are used in the following examples: wt %=weight percent, ppm=parts per million, mg=milligrams, kg=kilograms, g=gram, sec=seconds, min=minutes, hr or h=hours, mol %=mole percent, OC=degrees Celsius, mL=milliliter, L=liter, MPa=Mega-Pascals, G=g-force, NMR=nuclear magnetic resonance, Hz=hertz, MHz=megahertz, dNm=decinewton-meters, N=newtons, kN=kilonetwons, nm=nanometer, mm=millimeter, in =inches, kcps=thousand counts per second, rpm=revolutions per minute, μm=micrometer, and mW=milliwatts.

MATERIALS

| Material | Description |
|---|---|
| Acetone-d₆ | Hexadeuteroacetone, available from Sigma-Aldrich |
| Acetone | Available from Sigma-Aldrich |
| MT-990 | Available under the trade designation “THERMAX |
| carbon | FLOFORM MEDIUM THERMAL CARBON BLACK |
| black | N990,” from CanCarb Ltd., Medicine Hat, Alberta, Canada |
| ZnO | Available from Sigma-Aldrich |
| peroxide | Organic peroxide, available under the trade designation |
| | “TRIGONOX 101-50pd” from Akzo Nobel, Amsterdam, |
| | The Netherlands |
| TAIC | 70% Triallyl-isocyanurate on silica carrier available under |
| | the trade designation “Luvomaxx TAIC DL 70” from |
| | Lehmann & Voss, Hamburg, Germany |
| Lauryl | Lauryl glucoside available under the trade designation |
| glucoside | “GLUCOPON 600 CSUP” from BASF SE, Ludwigshafen, |
| | Germany |
| KMnO₄ | Available from Sigma-Aldrich |
| APS | Ammonium persulfate, available from Sigma-Aldrich |
| MgSO₄ | Available from Sigma-Aldrich |
| DIOFB | 1,4-diiodo-perfluorobutane, available from Tosoh Corp., |
| | Grove City, OH, USA |
| IVE | 1,1,2,2,3,3-hexafluoro-1-(1,1,2,2-tetrafluoro-2-iodoethoxy)- |
| | 3-[(trifluoroethenyl)oxy]propane, available from Anles, St. |
| | Petersburgh, Russia |
| DVE-3 | 1,1,2,2,3,3-hexafluoro-1,3- |
| | bis[(trifluoroethenyl)oxy]propane, available from Tosoh |
| | Corp. |
| IOFH | 1-iodoctafluorohexene, available from Anles |

### TEST METHODS

Solid Content:

Solid content (fluoropolymer content) was determined gravimetrically according to ISO 12086. A correction for non-volatile salts was not made.

Particle Size:

For Examples EX-1 through EX-4 and Comparative Examples CE-1 through CE-4, below, average particle sizes of polymer particles as polymerized were determined by electronic light scattering in accordance with ISO 13321 (1996) using a Autosizer 2c, available from Malvern Instruments Ltd., using a HeNe laser at a wavelength of 632 nm. Scattering measurements were carried out at a scattering angle of 90°. Before the measurement was started, the cuvette was rinsed several times with filtered (0.2 μm sieve from available from Macherey-Nagel Inc., Bethlehem, Pa., USA) deionized water to remove any dust. The sample dispersion was then filtered over a 50 μm nylon sieve (available from Eaton Filtrationstechnik) and a droplet of the sample (approximately 20-50 mg) was diluted in 0.01 M NaCl aqueous solution. The cuvette was filled up to half of the total volume. The cuvette was placed in the Autosizer 2c and the count rate was checked. When the count rate was in the range of 50 to 500 Kcps, the measurement was started and no further dilution was necessary. Each measurement run contained 10 single measurements (10 sec). Typically, measurements were carried out at 25° C. with the attenuation factor setting on “auto.” After each measurement, if the instrument software reported the measurement quality to be “good”, the average particle size (z-average) was recorded in nm. Otherwise, the measurement run was repeated.

Glass Transition Temperature (Tg):

The Tg can be measured by differential scanning calorimetry, for example using a Q200 modulated DSC, available from TA Instruments, New Castle. Del., USA. Conditions of measurements were: heating rate from −150° C. to 50° C. at 2-3° C./min, with a nitrogen (99.999% purity) gas purge at 60 mL/min. The modulation amplitude was +/−1° C. per minute during 60 sec.

Mooney Viscosity:

Mooney viscosities were determined in accordance with ASTM D1646-07(2012), 1 min pre-heat and a 10 min test at 121° C. (ML 1+10 @ 121° C.) using a MV2000 viscometer available from Alpha Technologies, Akron, Ohio, USA.

Polymer Composition:

¹⁹F NMR spectra were recorded with an Avance 400 (400.13 MHz) instrument, available from Bruker BioSpin Corporation, Billerica, Mass., USA. The partially fluorinated polymers were dissolved in acetone-d6, at a concentration of typically 50 mg/mL, 3000 scans per measurement were usually applied.

Reduced Viscosity:

Solution viscosities of diluted polymer solutions were determined usually on a 0.16% polymer solution in methylethylketone (MEK, available from Sigma-Aldrich) at 35° C. in accordance to DIN 53726. A Connon-Fenske-Routine-Viskosimeter, available from Schott, Mainz, Germany) fulfilling ISO/DIS 3105 and ASTM D 2515 was used for the measurements; the Hagenbach correcture was applied as usual.

I-content:

The iodine content was determined by elemental analysis using an ASC-240 S auto sampler from Enviroscience (Disseldorf, Germany), an Enviroscience AQF-2100 F combustion unit (software: “NSX-2100, version 1.9.8”; Mitsubishi Chemical Analytech Co., LTD.) an Enviroscience GA-210 gas absorption unit and a Metrohm “881 compac IC pro” liquid chromatography analyzer (software: Metrohm “Magic IC Net 2.3”, Riverview, Fla., USA). The iodine content is reported as the wt % versus the weight of the fluoropolymer.

Molar ratio of —CF₂CH₂I to —CF₂CH₂OH:

The endgroup concentration ratio of [—CF2CH2-I]/[—CF2CH2-OH] was evaluated from the ¹H nuclear magnetic resonance (NMR) spectra recorded with a Avance 400 (400 MHz) instrument available from Bruker BioSpin Corporation. The polymers were dissolved in acetone-d₆ at a concentration of typically 50 mg/mL, 3000 scans per measurement were usually applied. Chemical shifts δ (delta) are reported using tetramethylsilane (TMS, available from Sigma-Aldrich) as reference and in physical units of parts per million (ppm). The iodine containing polymers usually show well resolved signals in the ¹H NMR spectrum. The signals in the chemical shift range of 4.10≥delta≥3.65 ppm are attributed to the protons of —R_{f}—CF₂—CH₂—I endgroups. Each signal for the protons of the —R_{f}—CF₂—CH₂—I groups splits into a triplet due to ³J_{F-H} coupling (with 15 to 19 Hz), and their chemical shift delta is dependent on the penultimate monomer unit R_{f}. The triplet for the terminal protons in —CF₂—CH₂—CF₂—CH₂—I endgroups (VDF-VDF-I end group) is one of the most prominent signals. It is centered at about delta=3.87±0.05 ppm (δ_{ref}). The triplet for the two methylene protons in —CF₂—CH₂—OH endgroups, is located at a position of 0.08 ppm+/−0.01 ppm to the right of δ_{ref} (i.e., at delta=δ_{ref}−0.08 ppm+/−0.01 ppm). The signal can further be identified by its coupling constant (³J_{F-H} about 13 Hz).

The signals of the —R_{f}—CF₂—CH₂—I groups are then integrated from an area starting at 0.20 ppm to the left of δref and up to 0.07 ppm to the right of δref (i.e. at delta=δ_{ref}+0.20 ppm to δ_{ref}−0.07 ppm. For example, if δ_{ref} is at 3.90 ppm the signals of the area starting at 4.1 ppm and up to 3.83 ppm are integrated). This area (A_{CH21}) represents the concentration of —CF₂CH₂I endgroups.

The amount of —CF₂CH₂OH end groups is determined by integrating the area of the central signal of the —CF₂—CH₂—OH triplet (A_{CH2OH}). The areas of the two satellite signals surrounding the centers signal of the triplet are not included in the integration because they may (partially) overlap with signals from the —CF₂CH₂I end groups. Therefore the integration of the main signal of the triplet only gives a half of the area of the signals for the —CF₂CH₂OH methylene protons. Therefore, the ratio of [—CF₂CH₂—I]/[—CF₂CH₂—OH] end groups is calculated as: A_{CH21}/2 A_{CH2OH}.

Curable Compositions:

Curable compositions were made from each Example and Comparative Example on a two-roll mill by mixing 100 parts of fluorinated polymer, 30 parts of MT-990 carbon black, 3 parts of acid acceptor (ZnO), 2.50 parts of Peroxide, and 2.86 parts of TAIC. The curable composition was press-cured and then post cured.

Curing Properties:

Curing properties can be measured using a Monsanto Rheometer (at 177° C. in accordance with ASTM D 5289-93a), using a sealed die, with a die oscillation amplitude of 0.5° and frequency of 100 Hz, reporting minimum torque (ML), maximum torque (MH) and delta torque (which is the difference between MH and ML). Torque values are reported in dNM. Also reported is tan delta @ MH. Further reported are parameters indicating the curing speed such as Ts2 (the time required to increase the torque by two units over the ML); Tc50 (the time to increase torque above ML by 50% of delta torque), and Tc90 (the time to increase torque above ML by 90% of delta torque), all of which are reported in min.

Post Cure Physical Properties:

Press-cured sample sheets can be exposed to heat in air for 2 h at 230° C. The samples are returned to ambient temperature before testing.

Hardness of samples were measured according to ISO 7619-1 using a Zwick Roell HPE 11 Durometer from Zwick GmbH & Co., Ulm, Germany, Units are reported in points on the Shore A scale are mean values from five determinations.

Tensile Strength at Break, Elongation at Break, and Modulus at 100% Elongation were determined using an INSTRON mechanical tester available from Illinois Tool Works Inc., Norwood, Mass., USA, with a 1 kN load cell in accordance with DIN 53504 (1985). All tests were run at a constant cross head displacement rate of 200 mm/min.

Compression Set, 70 h at 200° C.:

The curable compositions were press-cured and post-cured to form buttons having a thickness of 0.24 in (6 mm) and a diameter of 12.4 mm. To prepare test samples, the Curable Composition was prepared on a mill and cured by pressing at about 40 bar (4.0 MPa) for 7 min at 177° C. Press-cured sample buttons were exposed to heat in air for 2 h at 230° C. (Post-Cure). The sample buttons were returned to ambient temperature before testing. Compression set of button specimens were measured according to ASTM D 395 (2008), Method B. Results are reported as a percentage of permanent set, and are measured at 25% deflection.

Compression Set, 22 h at 150° C.:

To prepare test samples, the Curable Composition was prepared on a mill and cured by pressing at about 40 bar (4.0 MPa) for 7 min at 177° C. followed by post curing for 2 h at 230° C. in air. The samples were returned to ambient temperature before testing. VDA compression set then was measured according to VDA 675218 (2004) standard. A 2 mm disc of a cured sample was placed in a stainless steel fixture and compressed at 50% deformation for 22 h at 150° C. Then, without releasing the compression, the sample was allowed to cool to room temperature (about 2-3 hr). The sample was removed from the stainless steel fixture and within 5 sec of removal, the difference in thickness was measured to determine the compression set. The value reported is the average % compression set for three discs.

Trouser Tear:

To prepare test samples, the Curable Composition was prepared on a mill and cured by pressing at about 40 bar (4.0 MPa) for 7 min at 177° C. followed by post curing for 2 h at 230° C. in air. The samples were returned to ambient temperature before testing. Trouser Tear measurements then were carried out on a Zwick010 machine, available from Zwick Roell Group (Ulm, Germany), according to ISO 34:1979 standard.

Extractables:

Disc samples with a thickness of 2 mm (about 10 g) were cut from post-cured plates of fluoroelastomer. Laboratory glass bottles were weighed on a micro balance to determine their initial weight. Each sample was then placed into a bottle and the bottle was reweighed to determine the weight of the fluoroelastomer sample (referred to as sample weight). 30 mL of acetone (HPLC grade) was added to cover the sample disc. The bottle was sealed and stored for 21 days at room temperature. After 21 days, the sample disc was removed from the bottle. The remaining solution was evaporated at room temperature until dryness and then placed in an oven at 100° C. for 16 h. After removal from the oven and cooling, the bottle was weighed (final weight). The total amount of extractables was determined by the difference between the final weight and the initial weight of the bottle multiplied by 100 and divided by the sample weight.

### EXAMPLES

Seed Composition

The seed was prepared by polymerizing VDF, TFE, HFP (40 g/120 g/39 g) in radical aqueous emulsion polymerization using lauryl glucoside as emulsifier. The seed composition had a solid content of 1.1 wt % o a pH of 4.3 and the average particle size (D50) was 38 nm.

### Example 1 (EX-1)

A 50 L-polymerization kettle was charged with 23 L of H₂O, 5 kg of the Seed Composition and stirred at an agitator speed of 240 rpm. The kettle was heated up to 70° C. Then the following monomers were charged: HFP until pressure increased to 12.0 bar (1.20 MPa), VDF until pressure increased from 12.1 to 14.8 bar (1.21 to 1.48 MPa), TFE until pressure increased to 17.0 bar (1.70 MPa). The polymerization was initiated by adding 9.0 g of APS. Over 340 min, 3.14 kg of VDF, 2.54 kg of TFE, 3.82 kg of HFP, 42 g of 1,4-diiodo-perfluorobutane (DIOFB) and 100 g of 1,1,2,2,3,3-hexafluoro-1-(1,1,2,2-tetrafluoro-2-iodoethoxy)-3-[(trifluoroethenyl)oxy]propane (IVE) were added continuously. The reaction was stopped. The resulting polymer dispersion had a solid content of 25 wt % after a polymerization time of 340 min. The average particle size of the polymer in the dispersion was 99 nm. The polymer was isolated by coagulation with MgSO₄. A Tg of −6° C. and a Mooney viscosity ML 1+10 of 26 was found. The molar composition was found to be 24 mol % TFE, 24 mol % HFP and 52 mol % VDF. The iodine content was 0.41 wt %. The reduced viscosity was 35 mL/g. The ratio of —CF₂CH₂I to —CF₂CH₂OH was 82.

### Comparative Example 1 (CE-1)

A 50 L-polymerization kettle was charged with 23 L of H₂O, 5 kg of the Seed Composition and stirred at an agitator speed of 240 rpm. The kettle was heated up to 70° C. Then the following monomers were charged: HFP until pressure increased to 12.0 bar (1.20 MPa), VDF until pressure increased from 12.1 to 14.8 bar (1.21 to 1.48 MPa), TFE until pressure increased to 17.0 bar (1.70 MPa). The polymerization was initiated by adding 9.0 g of APS. Over 409 min, 2.42 kg of VDF, 1.96 kg of TFE, 2.95 kg of HFP, 33 g of 1,4-diiodo-perfluorobutane (DIOFB) and 56 g of 1-iodoctafluorohexene (IOFH) were added continuously. The reaction was stopped. The resulting polymer dispersion had a solid content of 20 wt % after a polymerization time of 409 min. The average particle size of the polymer in the dispersion was 93 nm. The polymer was isolated by coagulation with MgSO₄. A T_{g} of −6° C. and a Mooney viscosity ML 1+10 of 34 was found. The molar composition was found to be 24 mol % TFE, 24 mol % HFP and 52 mol % VDF. The iodine content was 0.43 wt %. The reduced viscosity was 38 mL/g. The ratio of —CF₂CH₂I to —CF₂CH₂OH was 80.

### Example 2 (EX-2)

A 50 L-polymerization kettle was charged with 23 L of H₂O, 5 kg of the Seed Composition and stirred at an agitator speed of 240 rpm. The kettle was heated up to 70° C. Then the following monomers were charged: PMVE until 1.0 bar (0.10 MPa) was reached, HFP until pressure increased from 1.0 bar to 12.2 bar (0.10 to 1.22 MPa), VDF until pressure increased from 12.2 to 14.8 bar (1.22 to 1.48 MPa), TFE until pressure increased to 17.0 bar (1.70 MPa). The polymerization was initiated by adding 7.0 g of APS. Over 415 min, 0.11 kg of PMVE, 2.94 kg of VDF, 2.42 kg of TFE, 3.93 kg of HFP, 74 g of 1,4-diiodo-perfluorobutane (DIOFB), 31 g of 1,1,2,2,3,3-hexafluoro-1,3-bis[(trifluoroethenyl)oxy]propane (DVE-3) and 25 g of 1,1,2,2,3,3-hexafluoro-1-(1,1,2,2-tetrafluoro-2-iodoethoxy)-3-[(trifluoroethenyl)oxy]propane (IVE) were added continuously. The reaction was stopped. The resulting polymer dispersion had a solid content of 24 wt % after a polymerization time of 415 min. The average particle size of the polymer in the dispersion was 101 nm. The polymer was isolated by coagulation with MgSO₄. A Tg of −7° C. and a Mooney viscosity ML 1+10 of 16 was found. The molar composition was found to be 24 mol % TFE, 23 mol % HFP, 52 mol % VDF and 1 mol % PMVE. The iodine content was 0.48 wt %. The reduced viscosity was 34 mL/g. The ratio of —CF₂CH₂I to —CF₂CH₂OH was 85.

### Comparative Example 2 (CE-2)

A 50 L-polymerization kettle was charged with 23 L of H₂O, 5 kg of the Seed Composition and stirred at an agitator speed of 240 rpm. The kettle was heated up to 70° C. Then the following monomers were charged: PMVE until 1.0 bar (0.10 MPa) was reached, HFP until pressure increased from 1.0 bar to 12.2 bar (0.10 to 1.22 MPa), VDF until pressure increased from 12.2 to 14.8 bar (1.22 to 1.48 MPa), TFE until pressure increased to 17.0 bar (1.70 MPa). The polymerization was initiated by adding 10.0 g of APS. Over 334 min, 0.11 kg of PMVE, 2.94 kg of VDF, 2.42 kg of TFE, 3.93 kg of HFP, 74 g of 1,4-diiodo-perfluorobutane (DIOFB), 31 g of 1,1,2,2,3,3-hexafluoro-1,3-bis[(trifluoroethenyl)oxy]propane (DVE-3) and 20 g of 1-iodoctafluorohexene (IOFH) were added continuously. The reaction was stopped. The resulting polymer dispersion had a solid content of 24 wt % after a polymerization time of 334 min. The average particle size of the polymer in the dispersion was 101 nm. The polymer was isolated by coagulation with MgSO₄. A Tg of −7° C. and a Mooney viscosity ML 1+10 of 17 was found. The molar composition was found to be 24 mol % TFE, 23 mol % HFP, 52 mol % VDF and 1 mol % PMVE. The iodine content was 0.45 wt %. The reduced viscosity was 34 mL/g. The ratio of —CF₂CH2I to —CF₂CH₂OH was 71.

### Example 3 (EX-3)

A 50 L-polymerization kettle was charged with 23 L of H₂O, 5 kg of the Seed Composition and stirred at an agitator speed of 240 rpm. The kettle was heated up to 70° C. Then the following monomers were charged: PMVE until 1.0 bar (0.10 MPa) was reached, HFP until pressure increased from 1.0 bar to 12.2 bar (0.10 to 1.22 MPa), VDF until pressure increased from 12.2 to 14.8 bar (1.22 to 1.48 MPa), TFE until pressure increased to 17.0 bar (1.70 MPa). The polymerization was initiated by adding 7.0 g of APS. Over 416 min, 0.11 kg of PMVE, 2.94 kg of VDF, 2.42 kg of TFE, 3.93 kg of HFP, 43 g of 1,4-diiodo-perfluorobutane (DIOFB), 20 g of 1,1,2,2,3,3-hexafluoro-1,3-bis[(trifluoroethenyl)oxy]propane (DVE-3) and 35 g of 1,1,2,2,3,3-hexafluoro-1-(1,1,2,2-tetrafluoro-2-iodoethoxy)-3-[(trifluoroethenyl)oxy]propane (IVE) were added continuously. The reaction was stopped. The resulting polymer dispersion had a solid content of 24 wt % after a polymerization time of 416 min. The average particle size of the polymer in the dispersion was 102 nm. The polymer was isolated by coagulation with MgSO₄. A Tg of −6° C. and a Mooney viscosity ML 1+10 of 52 was found. The molar composition was found to be 24 mol % TFE, 23 mol % HFP, 52 mol % VDF and 1 mol % PMVE. The iodine content was 0.35 wt %. The reduced viscosity was 48 mL/g. The ratio of —CF₂CH₂I to —CF₂CH₂OH was 75.

### Comparative Example 3 (EX-3)

A 50 L-polymerization kettle was charged with 23 L of H₂O, 5 kg of the Seed Composition and stirred at an agitator speed of 240 rpm. The kettle was heated up to 70° C. Then the following monomers were charged: PMVE until 1.0 bar (0.10 MPa) was reached, HFP until pressure increased from 1.0 bar to 12.2 bar (0.10 to 1.22 MPa), VDF until pressure increased from 12.2 to 14.8 bar (1.22 to 1.48 MPa), TFE until pressure increased to 17.0 bar (1.70 MPa). The polymerization was initiated by adding 10.0 g of APS. Over 340 min. 0.11 kg of PMVE, 2.94 kg of VDF, 2.42 kg of TFE, 3.93 kg of HFP, 43 g of 1,4-diiodo-perfluorobutane (DIOFB), 20 g of 1,1,2,2,3,3-hexafluoro-1,3-bis[(trifluoroethenyl)oxy]propane (DVE-3) and 25 g of 1-iodoctafluorohexene (IOFH) were added continuously. The reaction was stopped. The resulting polymer dispersion had a solid content of 24 wt % after a polymerization time of 340 min. The average particle size of the polymer in the dispersion was 100 nm. The polymer was isolated by coagulation with MgSO₄. A Tg of −6° C. and a Mooney viscosity ML 1+10 of 50 was found. The molar composition was found to be 24 mol % TFE, 23 mol % HFP, 52 mol %/VDF and 1 mol % PMVE. The iodine content was 0.33 wt %. The reduced viscosity was 42 mL/g. The ratio of —CF₂CH₂I to —CF₂CH₂OH was 60.

### Example 4 (EX-4)

A 50 L-polymerization kettle was charged with 23 L of H₂O, 5 kg of Seed Composition, and stirred at an agitator speed of 240 rpm. The kettle was heated up to 70° C. Then the following monomers were charged: HFP until 12.0 bar (1.20 MPa) was reached, VDF until pressure increased from 12.1 to 14.8 bar (1.21 to 1.48 MPa), TFE until pressure increased to 17.0 bar (1.70 MPa). The polymerization was initiated by adding 13.0 g of APS. Over 250 min. 3.18 kg of VDF, 2.54 kg of TFE, 3.78 kg of HFP, 45 g of 1,4-diiodo-perfluorobutane (DIOFB) and 110 g of 1,1,2,2,3,3-hexafluoro-1-(1,1,2,2-tetrafluoro-2-iodoethoxy)-3-[(trifluoroethenyl)oxy]propane (IVE) were added continuously. The reaction was stopped. The resulting polymer dispersion had a solid content of 25 wt % after a polymerization time of 250 min. The average particle size of the polymer in the dispersion was 106 nm. The polymer was isolated by coagulation with MgSO₄. A Tg of −8° C. and a Mooney viscosity ML 1+10 of 20 was found. The molar composition was found to be 24 mol % TFE, 23 mol % HFP and 53 mol % VDF. The iodine content was 0.45 wt %. The reduced viscosity was 33 mL/g. The ratio of —CF₂CH21 to —CF₂CH₂OH was 78.

### Comparative Example 4 (CE-4)

A 50 L-polymerization kettle was charged with 23 L of H₂O, 5 kg of Seed Composition and stirred at an agitator speed of 240 rpm. The kettle was heated up to 70° C. Then the following monomers were charged: HFP until 12.0 bar (1.20 MPa) was reached, VDF until pressure increased from 12.1 to 14.8 bar 1.21 to 1.48 MPa), TFE until pressure increased to 17.0 bar (1.70 MPa). The polymerization was initiated by adding 13.0 g of APS. Over 343 min, 3.18 kg of VDF, 2.54 kg of TFE, 3.78 kg of HFP, 73 g of 1,4-diiodo-perfluorobutane (DIOFB), 33 g of 1,1,2,2,3,3-hexafluoro-1,3-bis[(trifluoroethenyl)oxy]propane (DVE-3) and 41 g of 1-iodoctafluorohexene (IOFH) were added continuously. The reaction was stopped. The resulting polymer dispersion had a solid content of 25 wt % after a polymerization time of 343 min. The average particle size of the polymer in the dispersion was 98 nm. The polymer was isolated by coagulation with MgSO₄. A Tg of −7° C. and a Mooney viscosity ML 1+10 of 22 was found. The molar composition was found to be 25 mol % TFE, 23 mol % HFP and 52 mol % VDF. The iodine content was 0.51 wt %. The reduced viscosity was 44 mL/g. The ratio of —CF₂CH₂I to —CF₂CH₂OH was 74.

TABLE 2
Mooney Viscosity and Cure Rheology

| | EX-1 | CE-1 | EX-2 | CE-2 | EX-3 | CE-3 | EX-4 | CE-4 |
|---|---|---|---|---|---|---|---|---|
| Mooney Viscosity | 26 | 34 | 16 | 17 | 52 | 50 | 20 | 22 |
| lodine (wt. %) | 0.41 | 0.43 | 0.48 | 0.45 | 0.35 | 0.33 | 0.45 | 0.51 |
| —CF₂CH₂I to | 82 | 80 | 85 | 71 | 75 | 60 | 78 | 74 |
| —CF₂CH₂OH ratio | | | | | | | | |

Monsanto MDR 6 min @ 177° C.

| | | | | | | | | |
|---|---|---|---|---|---|---|---|---|
| ML (dNm) | NM | NM | 0.49 | 0.59 | 0.17 | 0.18 | 0.68 | 0.69 |
| MH (dNm) | NM | NM | 31.26 | 29.38 | 27.83 | 26.54 | 30.61 | 29.49 |
| MH − ML (dNm) | NM | NM | 30.76 | 28.79 | 26.12 | 24.71 | 29.93 | 28.79 |
| Tan d @ ML | NM | NM | 1.200 | 1.202 | 0.764 | 0.773 | 1.201 | 0.991 |
| Tan d @ MH | NM | NM | 0.055 | 0.065 | 0.064 | 0.081 | 0.066 | 0.058 |
| Ts2 (min.) | NM | NM | 0.38 | 0.39 | 0.40 | 0.40 | 0.38 | 0.38 |
| Tc50 (min.) | NM | NM | 0.54 | 0.54 | 0.55 | 0.55 | 0.53 | 0.54 |
| Tc90 (min.) | NM | NM | 0.82 | 0.81 | 0.79 | 0.78 | 0.81 | 0.82 |

NM = Not Measured

TABLE 3
Results of post-cure physical property, compression set,
and tear resistance testing

| | | | | | |
|---|---|---|---|---|---|
| EX-2 | CE-2 | EX-3 | CE-3 | EX-4 | CE-4 |

Post cure 2 h @ 230° C.

| | | | | | | |
|---|---|---|---|---|---|---|
| Hardness Shore A | 75 | 75 | 73 | 73 | 75 | 75 |
| Modulus 100% (MPa) | 6.6 | 7.1 | 5.8 | 5.8 | 6.0 | 7.4 |
| Tensile (MPa) | 21.1 | 21.9 | 21.5 | 22.7 | 21.3 | 21.9 |
| Elongation (%) | 210 | 209 | 231 | 246 | 220 | 190 |
| Compression Set, | 19 | 22 | 22 | 24 | 18 | 18 |
| 70 h @ 200° C.: | | | | | | |
| Press cure 7 min | | | | | | |
| @ 177° C. | | | | | | |
| Compression Set, | 15 | 18 | 19 | 21 | 16 | 16 |
| 70 h @ 200° C.: | | | | | | |
| Post cure 2 h | | | | | | |
| @ 230° C. | | | | | | |
| Compression Set, | 30 | 37 | 39 | 42 | 33 | 43 |
| 22 h @ 150° C. | | | | | | |
| Trouser Tear (kN/m) | 3.7 | 2.8 | 3.7 | 2.8 | 3.5 | 3.0 |

TABLE 4
Extractables

| | EX-1 | CE-1 | EX-2 | CE-2 | EX-3 | CE-3 |
|---|---|---|---|---|---|---|
| Extractables (wt %) | 0.83 | 0.88 | 0.50 | 0.80 | 0.67 | 0.72 |

Foreseeable modifications and alterations of this invention will be apparent to those skilled in the art without departing from the scope and spirit of this invention. This invention should not be restricted to the embodiments that are set forth in this application for illustrative purposes.

1. An amorphous partially fluorinated polymer derived from:
(a) comonomers comprising: (i) 5-28 wt. % of tetrafluoroethylene; (ii) 30-70 wt. % of vinylidene fluoride; and (iii) a monomer selected from 10-45 wt. % of hexafluoropropylene and 10-40 wt. % of a perfluoro ether monomer of the formula
R_{f}—O—(CF₂)ₙ—CF═CF₂
wherein n is 1 or 0, and Rf represents a perfluoroalkyl residue which may or may not be interrupted by one or more than one oxygen atoms;
(h) 0.01-2 wt % of a perfluorinated iodinated vinyl ether based on the total amount of comonomer, wherein the perfluorinated iodinated vinyl ether has the formula:
F₂C═CF—(CF₂)ₘ—(O)ₒ—(CF₂)ₙ—O—(CF₂)ₚ—I
where m is 0 or 1; n is an integer of 0-5; o is 0 or 1; and p is an integer of 1-5, wherein when n is 0, o is 0; and
(c) 0.01-2 wt % of a chain transfer agent based on the total amount of comonomers wherein the chain transfer agent consists of a diiodo-fluoroalkane and a diiodo-methane.

2. The amorphous partially fluorinated polymer of claim 1, wherein the perfluoro ether monomer is selected from: perfluoro (methyl vinyl) ether, perfluoro (propyl vinyl) ether, perfluoro-methoxy-propylvinylether, perfluoro-2-propoxypropylvinyl ether, perfluoro (methyl allyl) ether, perfluoro (propyl allyl) ether, perfluoro-methoxy-propylallylether, and perfluoro-2-propoxypropylallyl ether.

3. The amorphous partially fluorinated polymer of claim 1, wherein the amorphous partially fluorinated polymer is further derived from 0.5-10 wt % of an alkene monomer consisting of an alkene and a fluorinated alkene.

4. The amorphous partially fluorinated polymer of claim 1, wherein the fluorinated alkene monomer consists of chlorotrifluoroethylene, vinyl fluoride, trifluoroethene, and 1,1,2,3,3,3-pentafluoropropene, 2,3,3,3-tetrafluoropropene.

5. The amorphous partially fluorinated polymer of claim 1, wherein the amorphous partially fluorinated polymer is further derived from a perfluorinated divinyl ether monomer.

6. The amorphous partially fluorinated polymer of claim 5, wherein the perfluorinated divinyl ether monomer is of the general formulas:
CF₂═CF—O—Rf₁—O—CF═CF₂ (I),
CF₂═CF—CF₂—O—Rf₁—O—CF₂—CF═CF₂ (II), or
CF₂═CF—CF₂—O—Rf₁—O—CF═CF₂ (III)
wherein Rf₁ is a linear or branched perfluoroalkanediyl, perfluorooxaalkanediyl or perfluoropolyoxaalkanediyl residue.

7. The amorphous partially fluorinated polymer of claim 1, wherein the perfluorinated iodinated vinyl ether consists of: ICF₂—O—CF═CF₂, ICF₂CF₂—O—CF═CF₂, ICF₂CF₂CF₂—O—CF═CF₂, and CF3CFICF₂—O—CF═CF₂.

8. The amorphous partially fluorinated polymer of claim 1, wherein the diiodo-fluoroalkane is a diiodo-perfluoropropane or a diiodo-perfluorobutane.

9. A cured fluoroelastomer composition comprising the reaction product of a curing reaction of the amorphous partially fluorinated polymer according to claim 1 and a peroxide cure system.

10. A shaped article comprising the cured amorphous partially fluorinated polymer according claim 9.

11. The shaped article of claim 10 selected from at least one of a hose, a tube, a seal, and an O-ring.

12. A method of polymerizing an amorphous partially fluorinated polymer comprising:
(a) providing the following comonomers: 5-28 wt. % of tetrafluoroethylene; 30-70 wt. % of vinylidene fluoride; and a monomer selected from 10-45 wt. % of hexafluoropropylene and 10-40 wt. % of a perfluoro ether monomer of the formula
R_{f}—O—(CF₂)ₙ—CF═CF₂
wherein n is 1 or 0, and Rf represents a perfluoroalkyl residue which may or may not be interrupted by one or more than one oxygen atoms; and 0.01-2 wt % of a perfluorinated iodinated vinyl ether based on the total amount of comonomers, wherein the perfluorinated iodinated vinyl ether is of the formula:
F₂C═CF—(CF₂)ₘ—(O)ₒ—(CF₂)ₙ—O—(CF₂)ₚ—I
where m is 0 or 1; n is an integer of 0-5; o is 0 or 1; and p is an integer of 1-5, wherein when n is 0, o is 0;
(b) contacting the comonomers and the perfluorinated iodinated vinyl ether with 0.01-2 wt % of a chain transfer agent wherein the chain transfer agent consists of a diiodo-fluoroalkane and a diiodo-methane; and
(c) contacting the comonomers and the perfluorinated iodinated vinyl ether with an initiator in the presence of water.

13. The method of claim 12, wherein the polymerization is substantially free of a fluorinated surfactant.

14. The method of claim 12, further comprising providing a seed composition in the presence of the monomers.

15. The method of claim 12, further comprising a sugar-based emulsifier.

16. The amorphous partially fluorinated polymer of claim 1, wherein the amorphous partially fluorinated polymer has an amount of extractables of less than 0.70 wt %.

17. The cured fluoroelastomer composition of claim 9, wherein the cured fluoroelastomer composition has a trouser tear of at least 3.5 kN/m or higher.

18. The method of claim 12, wherein the perfluorinated iodinated vinyl ether consists of: ICF₂—O—CF═CF₂, ICF₂CF₂—O—CF═CF₂, ICF₂CF₂CF₂—O—CF═CF₂, and CF3CFICF₂—O—CF═CF₂.

19. The method of claim 12, wherein the amorphous partially fluorinated polymer is further derived from 0.5-10 wt % of an alkene monomer consisting of an alkene and a fluorinated alkene.

20. The method of claim 12, wherein the amorphous partially fluorinated polymer is further derived from a perfluorinated divinyl ether monomer.
